(19) United States
(12) Patent Application Publication
(10) Pub. No.: US 2007/0237217 A1
(43) Pub. Date: Oct. 11, 2007

(54) User scheduling methods and apparatus for high-speed uplink packet access systems

(76) Inventors: Zukang Shen, Richardson, TX (US); Tarik Muharemovic, Dallas, TX (US)

Correspondence Address: TEXAS INSTRUMENTS INCORPORATED, P O BOX 655474, M/S 3999, DALLAS, TX, 75265, US

(21) Appl. No.: 11/399,207

(22) Filed: Apr. 6, 2006

(51) Int. Cl. H04B 17/00; H04L 27/00

(52) U.S. Cl. 375/227; 375/259

(57) ABSTRACT

User scheduling methods and apparatus for high-speed uplink packet access systems are disclosed. A disclosed example method comprises estimating a noise contribution due to other-cell interference for at least one previous transmit time interval, and selecting an uplink modulation and coding scheme for a wireless device for a current transmit time interval based on the estimated noise contribution.

### FIELD OF THE DISCLOSURE

This disclosure relates generally to high-speed uplink packet access systems and, more particularly, to user scheduling methods and apparatus for high-speed uplink packet access systems.

### BACKGROUND

Wireless communication systems consist of both downlink transmissions from a wireless basestation transceiver subsystem (BTS) to a plurality of wireless devices, and uplink transmissions from the same or a potentially different plurality of wireless devices to the BTS. In wireless communication systems such as, for example, high-speed uplink packet access systems, time is broken into transmit time intervals. During each transmit time interval, a set of wireless devices requesting to transmit (i.e., requesting devices) may be configured and/or enabled to transmit data towards the BTS. The configuring and/or enabling of requesting devices for a particular transmit time interval is commonly referred to in the industry as user scheduling. It will be readily apparent to persons of ordinary skill in the art that users themselves are not being scheduled, but transmissions by wireless devices associated with the users are being scheduled. In multiple cell wireless communication systems, the BTS associated with a particular cell performs the user scheduling for devices currently located within the cell.

User scheduling determines which wireless devices from a set of requesting devices may transmit during each transmit time interval and, for wireless devices allowed to transmit during a particular transmit time interval, which modulation and coding scheme (i.e., which set of uplink modulation and coding parameters) each wireless device should use. A modulation and coding scheme is selected from a set of modulation and coding schemes supported by the BTS based upon any variety of constraints such as, for example, desired data rate, desired bit and/or block error rate, overall system throughput, etc. The wireless devices may be configured with different and/or the same modulation and/or coding schemes. Additionally, the wireless devices may be configured with the same and/or different modulation and/or coding schemes for different transmit time intervals.

### BRIEF DESCRIPTION OF THE DRAWINGS

FIG. 1 is a schematic illustration of an example prior-art wireless system.

FIG. 2 illustrates an example prior-art manner of implementing the wireless device of FIG. 1.

FIG. 3 illustrates an example manner of implementing the example wireless basestation transceiver subsystem (BTS) of FIG. 1.

FIG. 4 is an example table of modulation and coding schemes.

FIG. 5 illustrates an example manner of implementing the example scheduler of FIG. 3.

FIG. 6 is an example table to store a probability density function (PDF)

FIG. 7 is an example table of block error rates (BLER) as a function of channel signal-to-noise ratio (SNR) and modulation and coding sets.

FIGS. 8, 9, 10 and 11 are flowcharts representative of example machine accessible instructions that may be executed to implement the example PDF computing logic, the example BLER computing logic, the example decision logic, the example orderer and/or, more generally, the example scheduler of FIG. 5.

FIG. 12 is a schematic illustration of an example processor platform that may be used and/or programmed to execute the example machine accessible instructions of FIGS. 8, 9, 10 and/or 11 to implement the example PDF computing logic, the example BLER computing logic, the example decision logic, the example orderer and/or, more generally, the example scheduler of FIG. 5.

### DETAILED DESCRIPTION

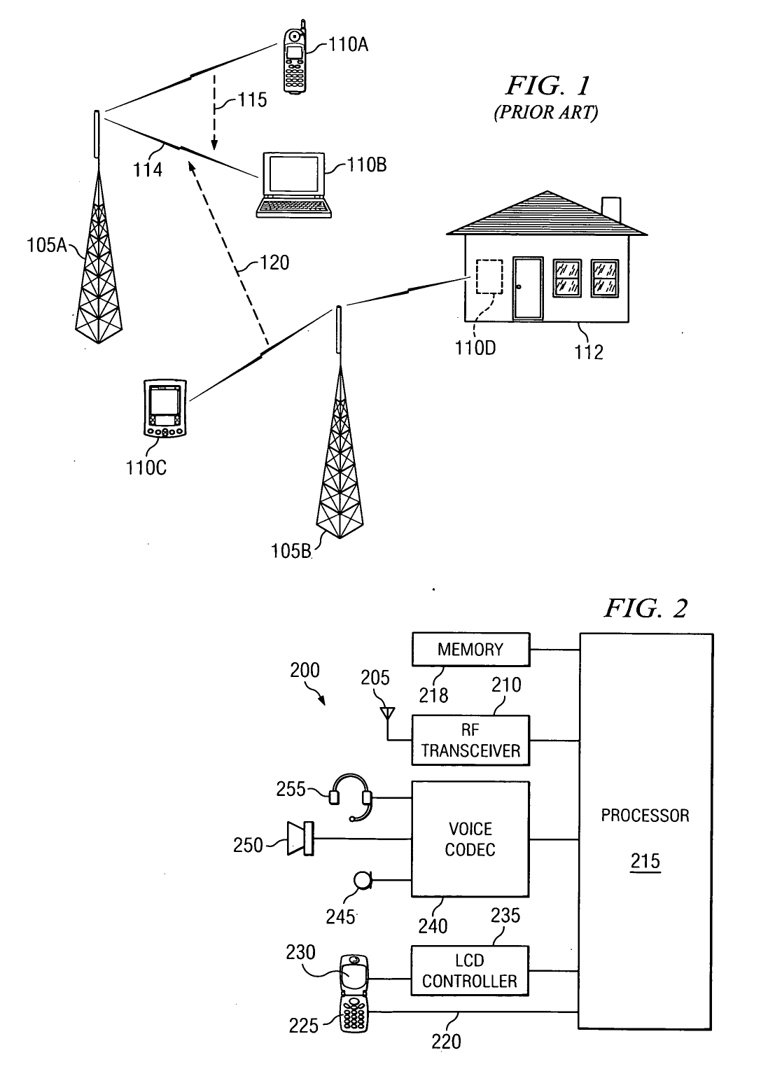

FIG. 1 is a schematic diagram of an example prior-art high-speed uplink packet access wireless communication system. To provide wireless communication services (e.g., telephone services, Internet services, messaging services, instant messaging services, video services, audio services, gaming services, etc.), the example wireless system of FIG. 1 includes of a plurality of wireless basestation transceiver subsystems (BTS) (two of which are respectively designated in FIG. 1 with reference numerals 105A and 105B). The BTSs 105A and 105B use any of a variety of conventional devices and/or techniques collectively provide wireless communication services over a geographic region. For example, the plurality of BTSs may be arranged in a grid with abutting and/or slightly overlapping coverage areas such that a fixed-location wireless device and/or a mobile wireless device moving through and/or within an area covered by the plurality of BTSs can, at all times, communicate with at least one of the BTSs.

The plurality of BTSs may provide wireless communication services to any of a plurality of conventional fixed-location and/or mobile wireless devices. Example mobile wireless devices include a wireless telephone (e.g., a cellular phone) 110A, a laptop computer 110B with wireless communication capabilities, a personal digital assistant (PDA) 110C, an iPod®, etc. Example fixed-location wireless devices include, for example, any variety of wireless terminal 110D that provides communication services to, for example, a residence or place of business 112.

In the illustrated example of FIG. 1, the data rate achievable via uplink and/or downlink transmissions between a BTS (e.g., the BTS 105A) and a wireless device (e.g., the laptop 110B) depend upon a variety of conditions such as, for example, the transmission channel and/or path 114 between the BTS 105A and the laptop 110B, background noise (e.g., additive white Gaussian noise (AWGN)), intra-cell interference from other devices communicating with the BTS 105A (e.g., intra-cell interference 115 caused by transmissions between the phone 110A and the BTS 105A), other-cell interference from other devices communicating with other BTSs (e.g., the BTS 105B) (e.g., other-cell interference 120 caused by transmissions between the PDA 110C and the BTS 105B), etc. The data rate(s) also depend upon the transmit power and/or modulation and coding scheme selected and/or used by the BTS 105A and/or the device 110B to transmit data

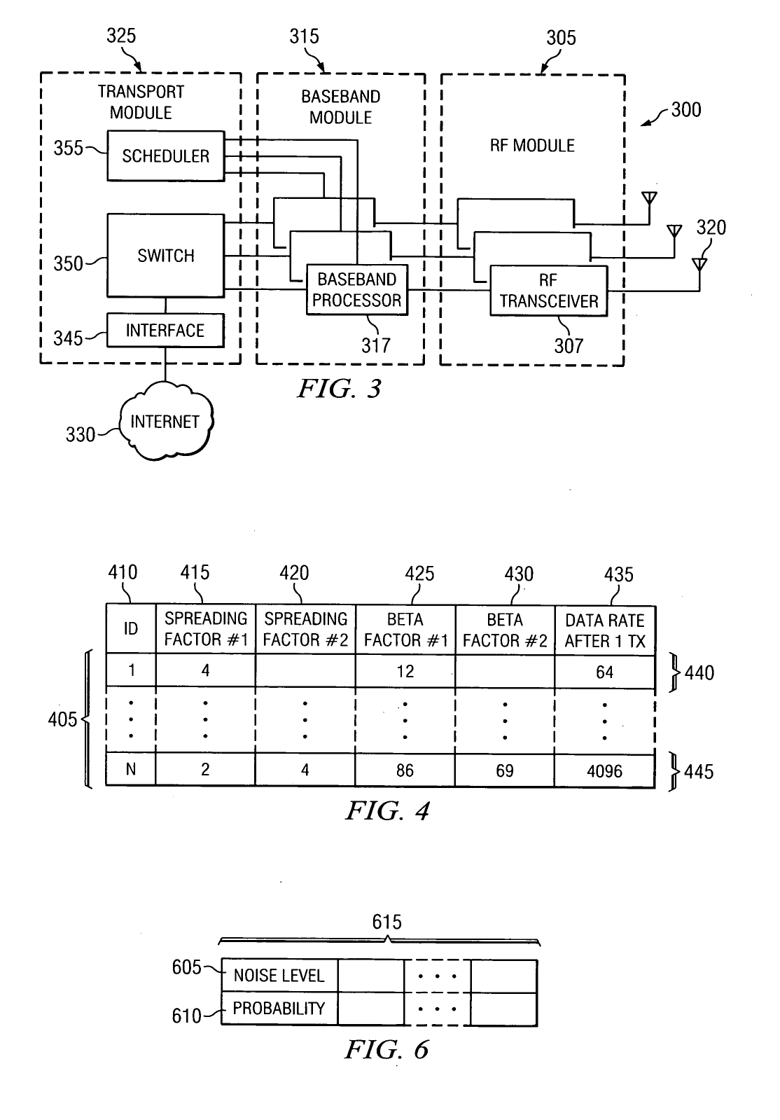

Using methods the apparatus disclosed below in connection with FIGS. 3-11, a BTS of the illustrated example performs user scheduling for the wireless devices with which it is communicating. For example, the BTS 105A of the illustrated example is responsible for user scheduling for the phone 110A and the laptop 110B. During each transmit time interval, the BTS 105A determines which of its associated devices are requesting to transmit data to the BTS 105A. The BTS 105A determines which of the associated devices are allowed to transmit and then determines which modulation and coding scheme each wireless device is to use to transmit uplink data. The user scheduling information (e.g., enablement and/or modulation and coding scheme selection) is provided to the requesting devices. Based upon the user scheduling information provided by the BTS 105A, the associated devices transmit uplink data. In the example system of FIG. 1, modulation and coding schemes are selected from a set of modulation and coding schemes supported by the example system.

FIG. 2 illustrates an example manner of implementing at least a portion of any of the plurality of example wireless devices 110A, 110B, 110C and 110D of FIG. 1. To support wireless communications with a BTS (e.g., the BTS 105A of FIG. 1), the example device 200 of FIG. 2 includes any of a variety of wireless antennas 205 and any of a variety of radio frequency (RF) transceivers 210. In particular, the antenna 205 and the RF transceiver 210 are able to receive, demodulate and decode wireless signals transmitted to the device 200 by, for example, the BTS 105A. Likewise, the RF transceiver 210 and the antenna 205 are able to encode, modulate and transmit any variety of high-speed uplink packet access wireless signals from the example device 200 to the BTS 105A.

As discussed above in connection with FIG. 1, the example device 200 of FIG. 2 sends a request to the BTS 105A when the device 200 desires to transmit data to the BTS 105A. The BTS 105A performs user scheduling for its associated requesting devices and provides user scheduling information (e.g., a transmit power, a selected modulation and coding scheme, etc.) to the example device 200 via wireless signals transmitted to the device 200. Using any variety of techniques and/or methods and based on the received user scheduling information, the example device 200 configures the RF transceiver 210 to transmit the uplink data to the BTS 105A using the received transmit power and/or modulation and coding scheme configuration.

To process received and decoded signals, to send uplink transmission requests, to receive user scheduling information and/or to provide data for uplink transmissions, the illustrated example of FIG. 2 includes a processor 215. The processor 215 may be any of a variety of processors such as, for example, a digital signal processor (DSP) from the TI® family of DSPs, an OMAP® processor from TI, an advanced reduced instruction set computing (RISC) machine (ARM) processor, etc. To store data and/or machine accessible instructions for the processor 215, the example device 200 includes a memory 218. In general, machine accessible instructions stored in the memory 218 may be executed by the processor 215 to provide one or more of a variety of services and/or functions implemented and/or provided by the example device 200 of FIG. 2. The memory 218 may contain any combination of random access memory (RAM) and/or read only memory (ROM). In particular, RAM may be implemented by dynamic random access memory (DRAM), Synchronous DRAM (SDRAM), and/or any other type of RAM device, and ROM may be implemented by flash memory and/or any other desired type of memory device.

In addition to handling receive data, transmit data, requests and/or user scheduling information, the processor 215 may receive user inputs or selections and/or provide a user interface for a user of the example device 200. For example, the processor 215 may receive inputs and/or selections 220 made by a user via a keyboard 225, and provide a user interface on a display 230 (e.g., a liquid crystal display (LCD)) via, for instance, an LCD controller 235. Other example input devices include a touch screen, a mouse, etc. The display 230 may be used to display any of a variety of information such as, for example, menus, caller identification information, a picture, video, a list of telephone numbers, a list of video and/or audio channels, phone settings, etc. Alternatively or additionally, the display 230 and/or the keyboard 225 may be used to provide any variety of messaging, data and/or web-based services such as, for example, web-surfing, electronic mail, instant messaging, etc. As such, uplink and/or downlink transmission data may include any variety of web page selections, electronic mail messages, instant messages, photographs, video clips, audio files, etc.

To provide, for example, telephone services, the example device 200 includes any of a variety of voice coder-decoders (codecs) 240 and one or more of a microphone 245, a speaker 250 or a jack for a headset 255. In particular, the processor 215 can receive a digitized and/or compressed voice signal from the microphone 245 or the headset 255 via the voice codec 240, and then transmit the digitized and/or compressed voice signal via the RF transceiver 210 and the antenna 205 to a BTS. Likewise, the processor 215 can receive a digitized and/or compressed voice signal from the BTS and output a corresponding analog signal via, for example, the speaker 250 or the headset 255 for listening by a user.

Although an example wireless device 200 has been shown in FIG. 2, wireless devices may be implemented using any of a variety of alternative and/or additional devices, circuits, modules, etc. Further, the devices, circuits, modules, elements, etc. illustrated in FIG. 2 may be combined, re-arranged, and/or implemented in any of a variety of ways. Further still, the example RF transceiver 210, the example processor 215, the example memory 218, the example voice codec 240, the LCD controller 235 and/or, more generally, the example device 200 may be implemented by hardware, software, firmware and/or any combination of hardware, software and/or firmware. While an example wireless device is illustrated in FIG. 2, persons of ordinary skill in the art will readily appreciate that the user scheduling methods and apparatus disclosed herein may be used to perform user scheduling for any type of wireless device.

FIG. 3 illustrates an example manner of implementing a BTS 300 (e.g., the BTS 105A or 105B of FIG. 1). The example BTS 300 of FIG. 3 can simultaneously provide wireless services to a plurality of wireless devices (e.g., the example wireless devices 110A-D of FIG. 2 and/or the example device 200 of FIG. 2). To provide the wireless services, the example BTS 300 includes, among other things, an RF module 305 and a baseband module 315. As is conventional, the RF module 305 includes any of a variety of RF transceivers 307, each of which can transmit and/or receive wireless signals to and/or from one or more wireless devices via an associated antenna 320. Likewise, the baseband module 315 includes any of a variety of baseband processors 317. In the illustrated example, each baseband processor 317 is paired with an RF transceiver 307 which is, in turn, paired with an antenna 320.

In the example of FIG. 3, data to be transmitted by the baseband module 315 and the RF module 305 is provided by a transport module 325. Likewise, data received by the RF module 305 and the baseband module 315 from a wireless device is provided to the transport module 325. The transmitted and/or received data may be associated with any of a variety of wireless services such as, for instance, a telephone call, an Internet service, a messaging service, an instant messaging service, an audio service, a video service, a data service, a gaming service, etc.

In the illustrated example of FIG. 3, the wireless service data may be associated with any of a variety of service providers. For a telephone service, the wireless service data may be associated with, for example, a public switched telephone network (PSTN). For an Internet and/or streaming video service, the wireless service data may be associated with, for example, an Internet service provider (ISP) communicatively coupled to the transport module 325 via, for instance, the Internet 330. In general, the wireless service data may be associated with any variety of data sources and/or service providers communicatively coupled to the transport module 325. For instance, telephone data may alternatively be associated with a voice over Internet (VoIP) service provider via the Internet 330.

To transmit and/or receive the wireless service data from and/or to the data sources and/or service providers, the example transport module 325 of FIG. 3 includes one or more conventional interfaces 345 suitable for exchanging data with the data sources and/or service providers. To connect data from the interfaces 345 with the baseband module 315, the example transport module 325 includes any of a variety of switches 350. The switch 350 may be controlled using any of a variety of techniques to bi-directionally route data between the interfaces 345 and the baseband module 315. For example, the switch 350 may be configured to route a voice data channel between a PSTN and a wireless service data channel associated with the baseband module 315 such that the voice data is transmitted to a particular wireless device.

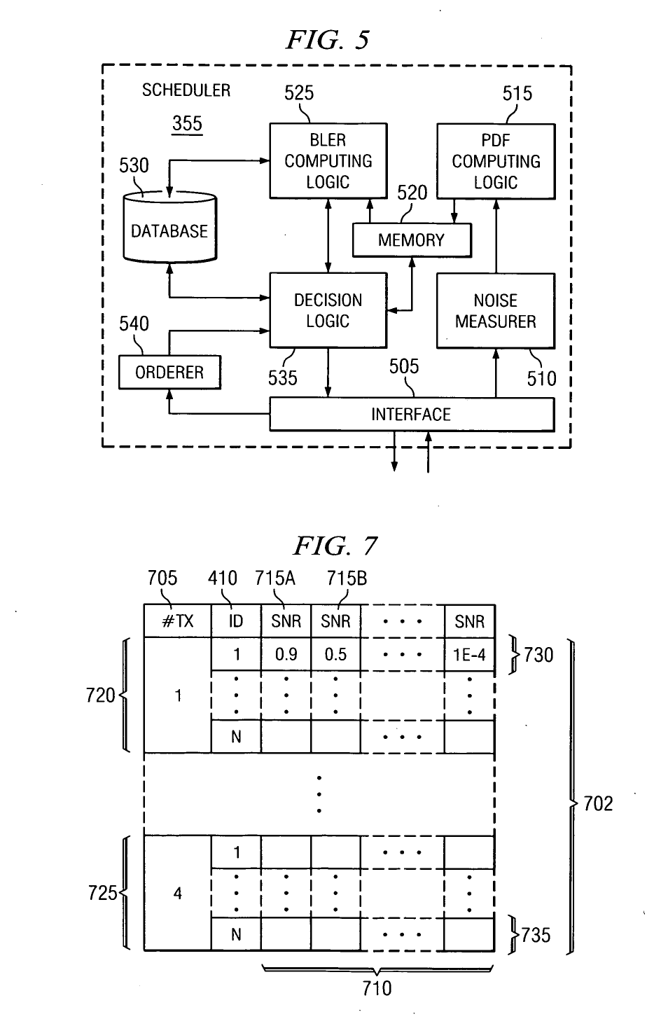

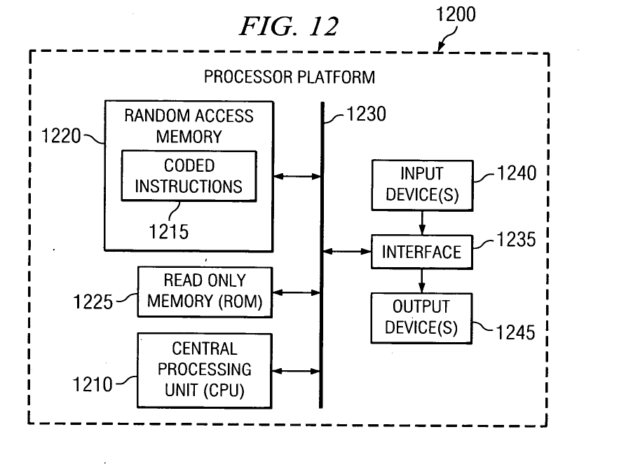

To perform user scheduling for the example BTS 300 of FIG. 3, the BTS 300 includes a scheduler 355. The scheduler 355 may be implemented using any of a variety of computing platforms (e.g., the example platform 1200 discussed below in connection with FIG. 12). The example scheduler 355 receives uplink wireless communication service requests from wireless devices via the baseband module 315, and determines if and/or how the wireless devices may transmit uplink data. That is, for each transmit time interval, the example scheduler 355 of FIG. 3 determines the set of requesting devices allowed to transmit uplink data. Based upon, for example, estimated other-cell interference, the example scheduler 355 determines which requesting devices will be allowed to transmit. For the requesting devices allowed to transmit, the scheduler 355 determines which modulation and coding scheme the devices are to use when transmitting uplink data. An example manner of implementing the scheduler 355 of FIG. 3 is discussed below in connection with FIG. 5. An example method of performing user scheduling is discussed below in connection with FIGS. 4 and 6-11.

While an example BTS 300 has been illustrated in FIG. 3, the elements, modules and/or devices illustrated in FIG. 3 may be combined, re-arranged, eliminated and/or implemented in any of a variety of ways. Further, the example baseband processor 317, the example baseband module 315, the example transport module 325, the example interface 345, the example switch 350, the example scheduler 355 and/or, more generally, the example BTS 300 may be implemented by hardware, software, firmware and/or any combination of hardware, software and/or firmware. Moreover, a BTS may include additional elements, modules and/or devices and/or may include more than one of any of the illustrated elements, modules and/or devices. For simplicity and ease of understanding, the following discussion references the example BTS 300 of FIG. 3.

FIG. 4 illustrates an example table to store and/or represent modulation and coding schemes 405 supported by the example BTS 300 of FIG. 3 and/or, more generally, the example wireless system of FIG. 1. For each requesting device allowed to transmit during a particular transmit time interval, the example scheduler 355 of FIG. 3 selects a modulation and coding scheme from the set 405 of modulation and coding schemes stored in the example table of FIG. 4. As illustrated in FIG. 4, each of the modulation and coding schemes 405 is identified with an identifier 410 and includes a first spreading factor 415, a second spreading factor 420, a first β factor 425, and a second β factor 430. Each of the modulation and coding schemes in the set 405 has an associated data rate 435. In the example of FIG. 4, the data rate 435 is the data rate achieved if the uplink data is transmitted only once. If a wireless device is configured to transmit uplink data multiple times to increase the probability of successful receipt of the uplink data at the BTS, the achieved data rate will be accordingly lower. If a particular modulation and coding scheme (e.g., scheme 440) only utilizes a single codeword, then the second spreading factor 420 and the second β factor 430 may be undefined and/or unused. The example scheme 440 of FIG. 1 uses a spreading factor 415 of four (4), a β of twelve (12) and achieves a single transmission data rate of 64 kilo bits per second (kbps). Another example scheme 445 shown in FIG. 4 utilizes two codewords and achieves a single transmission data rate of 4096 kbps. While an example table to store modulation and coding schemes is illustrated in FIG. 4, modulation and coding schemes may be stored and/or represented using any variety of table(s) and/or data structure(s). For simplicity and ease of understanding, the following discussion references the example table of FIG. 4.

FIG. 5 illustrates an example manner of implementing the example scheduler 355 of FIG. 3. To receive uplink transmission requests from wireless devices and to provide user scheduling information to the devices, the example scheduler 355 of FIG. 5 includes any variety of interface 505. The example interface 505 of FIG. 5 is configured to exchange data with the wireless devices via the baseband module 315 (FIG. 3) using any variety of communication protocols and/or techniques.

To measure the noise affecting uplink communications between a BTS and its associated wireless devices, the example scheduler 355 of FIG. 5 includes a noise measurer 510. Using any of a variety of techniques and/or methods, the example noise measurer 510 extracts and/or determines other-cell interference noise for each transmit time interval. The noise measurer 510 may also determine and/or estimate the amount of background noise (e.g., AWGN) present. In particular, the noise measurer 510 of the illustrated example processes uplink signals provided by the baseband module 315 to extract and/or determine other-cell interference noise.

To characterize the uplink other-cell interference noise, the example scheduler 355 of FIG. 5 includes a probability density function (PDF) computing logic 515. The example PDF computing logic 515 of FIG. 5 characterizes the other-cell interference by computing a PDF of the other-cell interference. In particular, the PDF computing logic 515 computes for each of a plurality of other-cell interference levels an associated probability that a particular other-cell interference level is present. As such, the PDF represents the likelihoods (i.e., probabilities) that an uplink transmission will encounter an other-cell interference of varying levels and/or strength. The PDF computing logic 515 stores the PDF in any variety of memory 520. The PDF estimated by the PDF computing logic 515 may also include background and/or intra-cell interference. In the illustrated example, to estimate and/or determine the PDF, the PDF computing logic 515 assigns each of the signals received from the noise measurer 510 for a plurality of previous transmit time intervals into categories based upon their level and then computes the probability of each category. The PDF calculation may be repeated each transmit timer interval or less frequently, and/or may use all of or any portion of the signals received from the noise measurer 510. Additionally or alternatively, exponential weighted averaging may be used. Persons of ordinary skill in the art will readily appreciate that other methods and/or techniques for determining and/or estimating the PDF may be used.

FIG. 6 illustrates an example table for storing a PDF representative of the other-cell interference, of background noise and/or intra-cell interference. The example table of FIG. 6 contains associated pairs of noise level 605 and probability 610. In particular, the probability 610 represents the likelihood that an uplink transmission will encounter the associate noise level 605. As illustrated in FIG. 6, the example table contains probabilities for a plurality of noise interference levels. In general, a sum of the probabilities will substantially equal one hundred percent (100%). However, the example table of FIG. 6 may be used to represent, for example, only a statistically significant portion of the PDF and, thus, a sum of the probabilities may be less than 100%. While an example table to store a PDF is illustrated in FIG. 6, PDF data may be stored and/or represented using any variety of table(s) and/or data structure(s). For simplicity and ease of understanding, the following discussion references the example table of FIG. 6.

FIG. 7 illustrates an example table for storing block error rate (BLER) values as a function of channel signal-to-noise ratio (SNR) (or channel noise) and modulation and coding scheme. The example table of FIG. 7 includes a plurality of entries 702, each of which correspond to a particular number of times 705 the uplink transmit data is to be transmitted and a given modulation and coding scheme identifier 410 (FIG. 4). Each of the entries 702 contain a plurality of BLER values 710 corresponding to a plurality of channel SNR values 715A, 715B, etc. For instance, a first subset 720 of the entries 702 contains BLER values for a single transmission while another subset 725 contains BLER values when uplink data is transmitted four (4) times. Within the first subset 720, an example entry 730 corresponds to modulation and coding scheme identifier “1” and has a BLER of 0.9 for SNR 715A, a BLER of 0.5 for SNR 715B, etc. Likewise, an entry 735 corresponds to four (4) transmissions with modulation and coding scheme identifier “N”.

Using any variety of indexing technique(s) and/or method(s) and for a particular number of transmissions 705, a particular modulation and coding scheme identifier 410 and a particular channel SNR, the example table illustrated in FIG. 7 may be used to identify the corresponding BLER. In the example of FIG. 7, the channel SNR values 715A, 715B, etc. correspond to the noise levels 605 of FIG. 6. For example, the channel SNR value 715A may be computed by dividing the transmit signal power by the first noise level 605 of FIG. 6. While an example table to store BLER data is illustrated in FIG. 7, BLER data may be stored and/or represented using any variety of table(s) and/or data structure(s). For simplicity and ease of understanding, the following discussion references the example table of FIG. 7.

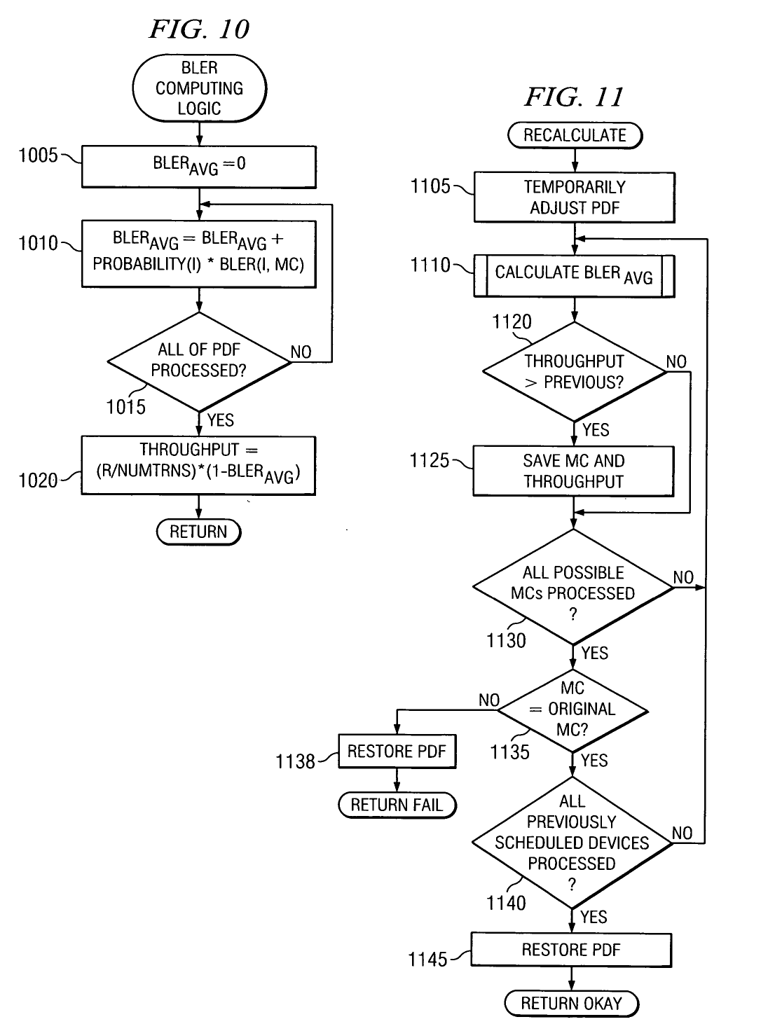

Returning to FIG. 5, to compute an average block error rate (BLER_{AVG}) for a particular modulation and coding scheme, the example scheduler 355 of FIG. 5 includes a block error rate (BLER) computing logic 525. To compute BLER_{AVG} values, the example BLER computing logic 525 of FIG. 5 utilizes a BLER table (e.g., the example table of FIG. 7) stored in a database 530 that contains BLER values as a function of (1) number of transmissions, (2) channel SNR (or channel noise) and (3) modulation and coding scheme. The BLER_{AVG} is computed by multiplying each of the BLER values (e.g., values of entry 730) with each of the probabilities 610 of each noise level 605 and summing together the results. For instance, for a particular modulation and coding scheme 410 and number of transmissions 705, the BLER computing logic 525 of the illustrated example computes the BLER_{AVG} using, for example, the following mathematical expression:

$${BLER}_{AVG} ( ID , NumTrans ) = {\sum }_{i = 0}^{N} BLER ( i , ID , NumTrans ) * Probability ( i ) , \qquad ( EQN 1 )$$

where ID is the identifier 410 of the particular modulation and coding scheme, NumTrans is the number of transmissions 705, and N is the number of paired values in the PDF 615. The expected throughput of the modulation and coding scheme can be estimated by dividing the rate 435 (FIG. 4) by the number of uplink transmissions and multiplying the result by the probability of successful transmission. For example, the expected throughput can be computing using the mathematical expression illustrated in EQN 2.

$$Throughput ( ID , NumTrans ) = \frac{DataRate ( ID )}{NumTrans} [ 1 - {BLER}_{AVG} ( ID , NumTrans ) ] , \qquad ( EQN 2 )$$

where ID is the identifier 410 of the particular modulation and coding scheme, and NumTrans is the number of transmissions 705. An example process to compute BLER_{AVG} and Throughput is discussed below in connection with FIG. 10.

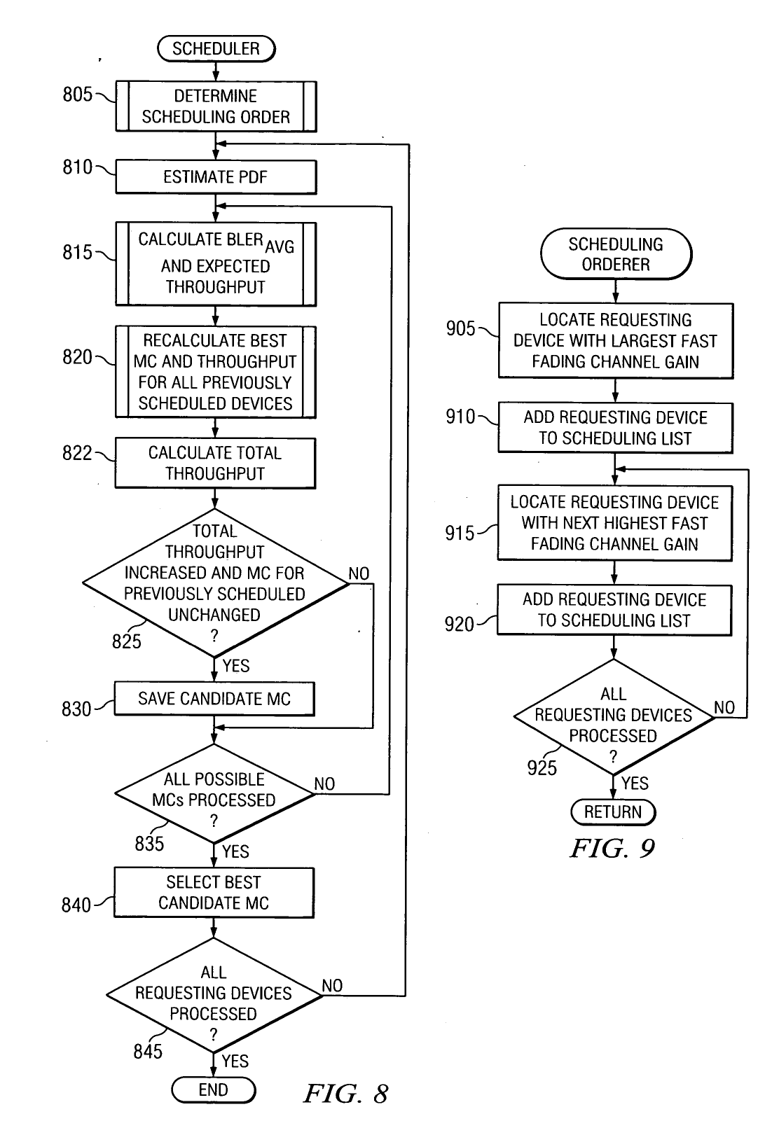

To determine which requesting devices should be allowed to transmit during a particular transmit time interval and to select the modulation and coding scheme(s) for devices allowed to transmit, the example scheduler 355 of FIG. 5 includes decision logic 535. The example decision logic 535 of FIG. 5 queries the example BLER computing logic 525 for BLER_{AVG} values for a multitude of modulation and coding schemes 410 and numbers of transmissions 705. Based upon the corresponding expected throughputs (e.g., the values determined via EQN 2) and overall system throughputs, the decision logic 535 selects a modulation and coding scheme. An example overall system throughput (i.e., total throughput) is a sum of the expected throughputs of all scheduled requesting devices. An example process to implement the example decision logic 535 of FIG. 5 is discussed below in connection with FIGS. 8 and 11.

To determine in which order the decision logic 535 should consider and/or schedule requesting devices, the example scheduler 355 of FIG. 5 includes an orderer 540. The example orderer 540 of FIG. 5 orders the list of requesting devices based upon one or more criteria such as, for example, proportional fairness or fast fading channel gain. For instance, devices having the highest fast fading channel gain are scheduled first by the example scheduler 355. An example process to implement the example orderer 540 of FIG. 5 is discussed below in connection with FIG. 9.

Although an example scheduler 355 has been illustrated in FIG. 5, a scheduler may be implemented using any of a variety of alternative and/or additional devices, circuits, modules, etc. Further, the devices, circuits, modules, elements, etc. illustrated in FIG. 5 may be combined, re-arranged, and/or implemented in any of a variety of ways. Further still, the example interface 505, the example noise measurer 510, the example PDF computing logic 515, the example BLER computing logic 525, the example decision logic 535, the example order 540 and/or, more generally, the example scheduler 355 may be implemented by hardware, software, firmware and/or any combination of hardware, software and/or firmware. For simplicity and ease of understanding, the following discussion references the example scheduler 355 of FIG. 5.

FIGS. 8, 9, 10 and 11 are flowcharts representative of example machine accessible instructions that may be executed to implement the example decision logic 535, the example orderer 540, the example PDF computing logic 515 and/or, more generally, the example scheduler 355. The example machine accessible instructions of FIGS. 8-11 may be executed by a processor, a controller and/or any other suitable processing device. For example, the example machine accessible instructions of FIGS. 8-11 may be embodied in coded instructions stored on a tangible medium such as a flash memory, or RAM associated with a processor (e.g., the example central processing unit 1210 discussed below in connection with FIG. 12). Alternatively, some or all of the example flowcharts of FIGS. 8-11 may be implemented using an application specific integrated circuit (ASIC), a programmable logic device (PLD), a field programmable logic device (FPLD), discrete logic, hardware, firmware, etc. Also, some or all of the example flowcharts of FIGS. 8-11 may be implemented manually or as combinations of any of the foregoing techniques, for example, a combination of firmware and/or software and hardware. Further, although the example machine accessible instructions of FIGS. 8-11 are described with reference to the flowcharts of FIGS. 8-11, persons of ordinary skill in the art will readily appreciate that many other methods of implementing the example decision logic 535, the example order 540, the example PDF computing logic 515 and/or, more generally, the example scheduler 355 may be employed. For example, the order of execution of the blocks may be changed, and/or some of the blocks described may be changed, eliminated, sub-divided, or combined. Additionally, persons of ordinary skill in the art will appreciate that the example machine accessible instructions of FIGS. 8-11 may be carried out sequentially and/or carried out in parallel by, for example, separate processing threads, processors, devices, circuits, etc.

The example machine accessible instructions of FIG. 8 begin with the orderer 540 determining an order in which the requesting devices should be scheduled by the decision logic 535 (block 805). For instance, the scheduling order may be determined by executing the example machine accessible instructions of FIG. 9. Starting with the first of the ordered requesting devices, the PDF computing logic 515 then computes and/or estimates the probabilities 610 associated with the noise levels 610 (block 810). For the first requesting device processed by the decision logic 535, the PDF computed by the PDF computing logic 515 includes other-cell interference and AWGN. For scheduling of the remaining requesting devices, the PDF also includes intra-cell interference from the previously scheduled devices.

Starting with one of the modulation and coding schemes 405, the decision logic 535 queries the BLER computing logic 525 for the corresponding BLER_{AVG} and then computes the expected throughput of the presently considered modulation and coding scheme (block 815). The BLER_{AVG} and throughput may be computed by, for example, executing the example machine accessible instructions of FIG. 10. Assuming, for the moment, that the presently considered current modulation and coding scheme is selected for the presently considered device, the decision logic 535 recalculates the best modulation and coding (MC) scheme and throughput for the previously scheduled devices (block 820) by, for example, executing the example machine accessible instructions of FIG. 11. The decision logic 535 then calculates the total throughput (i.e., overall system uplink throughput) as the sum of the expected throughput of the presently considered modulation and coding scheme for the presently considered device computed at block 815 and the re-calculated throughputs for each of the previously scheduled devices computed at block 820 (block 822).

If the presently considered modulation and coding scheme for the presently considered device would increase the total throughput and would not result in the selection of a different modulation and coding scheme for any of the previously scheduled devices (e.g., a return result of OKAY) (block 825), the decision logic 535 saves the presently considered modulation and coding scheme as a candidate modulation and coding scheme for the presently considered device (block 830). Control then proceeds to block 835. If the presently considered modulation and coding scheme for the presently considered device would not increase the total throughput of the system or would cause a different modulation and coding scheme to be selected for any of the previously scheduled devices (e.g., a return result of FAIL) (block 825), control skips block 830 and proceeds to block 835.

At block 835, if not all possible modulation and coding schemes have been considered for the presently considered device, control returns to block 815 to consider the next modulation and coding scheme. When all possible modulation and coding schemes have been considered for the presently considered device (block 835), the decision logic 535 selects the modulation and coding scheme from the list of saved candidate modulation and coding schemes that provides the highest overall system throughput and/or meets the data rate requested by the presently considered device (block 840). If all requesting devices have been considered (block 845), execution of the example machine accessible instructions of FIG. 8 is ended. If not all requesting devices have been considered (block 845), control returns to block 810 to process the next device in the ordered list of requesting devices.

Any variety of alternative and/or additional constraints may be checked at block 825 to determine if a presently considered modulation and coding scheme for a presently considered device is an allowable candidate. For example, at block 825, the decision logic 535 could simply check that the total throughput computed at block 822 has increased without checking if the modulation and coding schemes for the previously scheduled devices remain the same.

The example machine accessible instructions of FIG. 9 begin with the orderer 540 identifying the requesting device having the largest fast fading channel gain based upon, for example, one or more variables provided by the baseband module 315 (block 905). The identified requesting device having the largest fast fading channel gain is added to the scheduling list (block 910). The order 540 then identifies the requesting device with the next largest fast fading channel gain (block 915) and adds the next identified requesting device to the scheduling list (block 920). When all requesting devices have been processed (block 925), control returns from the example machine accessible instructions of FIG. 9 to, for example, the machine accessible instructions for FIG. 8 (e.g., to block 810). If not all requesting devices have been processed (block 925), control returns to block 915 to identify the requesting device with the next largest fast fading channel gain.

The example machine accessible instructions of FIG. 10 begin with the BLER computing logic 525 initializing BLER_{AVG} to zero (0) (block 1005). The BLER computing logic 525 then multiplies a probability 610 with the corresponding BLER 702 for the presently considered modulation and coding scheme and number of transmissions, and adds the result to the current BLER_{AVG} (block 1010). When all of entries 615 of the PDF have been processed (block 1015), the throughput is computed by dividing the single transmission data rate 435 for the presently considered modulation and coding scheme by the number of transmissions, and multiplying by the probability of receiving the data without error (e.g., 1−BLER_{AVG}) (block 1020). Control returns from the example machine accessible instructions of FIG. 10 to, for example, the machine accessible instructions for FIG. 8 (e.g., to block 820). Returning to block 1015, if not all of the entries 615 of the PDF have been processed, control returns to block 1010 to process the next probability value 610.

The example machine accessible instructions of FIG. 11 begin when the PDF computing logic 515 temporarily adjusts the PDF to reflect the presently considered modulation and coding scheme for the presently considered device (block 1105). For each of the previously scheduled devices and for each of the possible modulation and coding schemes, the BLER computing logic 525 computes the BLER_{AVG} (block 1110) by, for example, executing the example machine accessible instructions of FIG. 10. If the throughput for the presently considered modulation and coding scheme for the presently considered previously scheduled device is greater than the already considered modulation and coding schemes (block 1120), the decision logic 535 saves the presently considered modulation and coding scheme and throughput (block 1125). Control then proceeds to block 1130. If the throughput for the presently considered modulation and coding scheme for the presently considered previously scheduled device is less than or equal to the already considered modulation and coding schemes (block 1120), control proceeds to block 1130 and the presently considered modulation and coding scheme is not saved.

When all modulation and coding schemes have been processed for the presently considered previously scheduled devices (block 1130), control proceeds to block 1135. If not all modulation and coding schemes have been processed (block 1130), control returns to block 1110 to process the next modulation and coding scheme.

If the modulation and coding scheme saved at block 1125 is not the original modulation and coding scheme for the presently considered previously scheduled device (block 1135), the original PDF is restored (block 1138). Control then returns from the example machine accessible instructions of FIG. 11 to, for example, the example machine accessible instructions of FIG. 8 with a FAILURE return value. If the modulation and coding scheme saved at block 1125 is the original modulation and coding scheme for the presently considered previously scheduled device (block 1135), the decision logic 535 determines if all previously scheduled devices have been processed (block 1140). If not all previously scheduled devices have been processed (block 1140), control returns to block 1110 to process the next previously scheduled device. If all previously scheduled devices have been processed (block 1140), the original PDF is restored (block 1145). Control then returns from the example machine accessible instructions of FIG. 11 to, for example, the example machine accessible instructions of FIG. 8 with a SUCCESS return value.

FIG. 12 is a schematic diagram of an example processor platform 1200 that may be used and/or programmed to carry out the example machine accessible instructions illustrated in FIGS. 8-11 to implement the example decision logic 535, the example order 540, the example PDF computing logic 515 and/or, more generally, the example scheduler 355. For example, the processor platform 1200 can be implemented by one or more general purpose microprocessors, microcontrollers, etc.

The processor platform 1200 of the example of FIG. 12 includes a general purpose programmable processor 1210. The processor 1210 executes coded instructions 1227 present in main memory of the processor 1210 (e.g., within a random access memory (RAM) 1225). The processor 1210 may be any type of processing unit, such as a DSP from the TI® family of DSP, an OMAP® processor from TI, an ARM processor, or any of a variety of microprocessor or microcontroller. The processor 1210 may carry out, among other things, the example machine accessible instructions illustrated in FIGS. 8-11.

The processor 1210 is in communication with the main memory (including a ROM 1220 and the RAM 1225) via a bus 1205. The RAM 1225 may be implemented by DRAM, SDRAM, and/or any other type of RAM device. The ROM 1220 may be implemented by flash memory and/or any other desired type of memory device. Access to the memory 1220 and 1225 is typically controlled by a memory controller (not shown) in a conventional manner. The RAM 1225 and/or the ROM 1220 may be used, for example, to implement the memory 520 and/or the database 530 (FIG. 5).

The processor platform 1200 also includes a conventional interface circuit 1230. The interface circuit 1230 may be implemented by any type of well-known interface standard, such as an external memory interface, serial port, general purpose input/output, etc.

One or more input devices 1235 and one or more output devices 1240 are connected to the interface circuit 1230. The input devices 1235 and output devices 1240 may be used, for example, to implement the example interface 505 (FIG. 5).

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method comprising:
estimating a noise contribution due to other-cell interference for at least one previous transmit time interval; and
selecting an uplink modulation and coding scheme for a wireless device for a current transmit time interval based on the estimated noise contribution.

2. A method as defined in claim 1, wherein the wireless device is one of a plurality of high-speed packet access wireless devices requesting to transmit data in the current transmit time interval.

3. A method as defined in claim 1, wherein estimating the noise contribution due to other-cell interference comprises computing a probability density function (PDF) of the other-cell interference.

4. A method as defined in claim 3, wherein computing the probability density function of the other-cell interference comprises:
measuring a plurality of other-cell interference signals for respective ones of a plurality of transmit time intervals; and
computing the PDF of the plurality of measured other-cell interference signals.

5. A method as defined in claim 4, wherein an other-cell interference signal is measured each transmit time interval, and wherein the computing of the PDF is performed less often than every transmit time interval.

6. A method as defined in claim 1, wherein selecting the modulation and coding scheme for the wireless device for a current transmit time interval based on the estimated noise contribution comprises:
computing an average block error rate based on the estimated noise contribution; and
selecting the modulation and coding scheme that maximizes an expected data rate.

7. A method as defined in claim 6, further comprising determining expected data rates for a plurality of modulation and coding schemes.

8. A method as defined in claim 6, wherein the estimated noise contribution is represented as a plurality of associated probabilities and signal-to-noise ratios, and wherein the average block error rate is computed by:
determining a block error rate associated with each of the plurality of signal-to-noise ratios;
for each of the plurality of signal-to-noise ratios, multiplying the determined block error rate with the probability associated with the signal-to-noise ratio; and
adding together outputs of the multiplying.

9. A method as defined in claim 6, further comprising:
updating the estimated noise contribution to include an intra-cell interference resulting from the selected modulation and coding scheme; and
selecting a second modulation and coding scheme for a second wireless device for the current transmit time interval based on the updated estimated noise contribution.

10. A method as defined in claim 9, wherein the second modulation and coding scheme is selected to increase a total throughput.

11. A method as defined in claim 1, further comprising selecting the wireless device based upon at least one of a proportional fairness or a fast fading channel gain.

12. A method as defined in claim 1, further comprising ranking a plurality of wireless devices, and selecting modulation and coding schemes for the plurality of wireless devices based upon the estimated noise contribution and based upon the ranking.

13. A method as defined in claim 12, wherein the ranking is based upon at least one of a proportional fairness or a fast fading channel gain.

14. An apparatus comprising:
a baseband module to measure an other-cell interference signal for at least one previous transmit time interval; and
a scheduler to:
determine a probability density function (PDF) of the other-cell interference signal; and
select a modulation and coding scheme for a wireless device for a current transmit time interval based on the PDF.

15. An apparatus as defined in claim 14, wherein the wireless devices is one of a plurality of high-speed packet access wireless devices requesting to transmit data to the baseband module in the current transmit time interval.

16. An apparatus as defined in claim 14, wherein the scheduler comprises:
PDF computing logic to compute the PDF;
block error rate computing logic to compute an average block error rate from the PDF; and
decision logic to select the modulation and coding scheme based on the average block error rate.

17. An apparatus as defined in claim 16, wherein the PDF computing logic is configured to:
receive a plurality of other-cell interference signals for respective ones of a plurality of previous transmit time intervals; and
compute the PDF of the plurality of measured other-cell interference signals.

18. An apparatus as defined in claim 16, wherein the decision logic selects the modulation and coding scheme for the wireless device for the current transmit time interval based on the average block error rate by:
determining expected data rates for a plurality of modulation and coding schemes; and
selecting the modulation and coding scheme having a largest expected data rate.

19. An apparatus as defined in claim 18, wherein the PDF is represented as a plurality of associated probabilities and signal-to-noise ratios, and wherein the apparatus further comprises:
a memory to store a plurality of block error rates for respective ones of a plurality of signal-to-noise ratios, the block error rate computing logic configured to use the table to determine a block error rate for each of the plurality of signal-to-noise ratios based on a particular modulation and coding scheme;
a multiplier to multiply the determined block error rate of each signal-to-noise ratio with the probability associated with the corresponding signal-to-noise ratio; and
a summer to add together outputs of the multiplier.

20. An apparatus as defined in claim 16, wherein the PDF computing logic updates the PDF to include an intra-cell interference resulting from the selected modulation and coding scheme; and wherein the decision logic selects a second modulation and coding scheme for a second wireless device for the current transmit time interval based on the updated PDF.

21. An apparatus as defined in claim 20, wherein the second modulation and coding scheme is selected to increase a total throughput.

22. An article of manufacture storing machine accessible instructions which, when executed, cause a machine to:
estimate a noise contribution due to other-cell interference for at least one previous transmit time interval; and
select an uplink modulation and coding scheme for a wireless device for a current transmit time interval based on the estimated noise contribution, wherein the wireless device is one of a plurality of high-speed packet access wireless devices requesting to transmit data in the current transmit time interval.

23. An article of manufacture as defined in claim 22, wherein the machine accessible instructions, when executed, cause the machine to estimate the noise contribution due to other-cell interference by computing a probability density function (PDF) of the other-cell interference.

24. An article of manufacture as defined in claim 23, wherein the machine accessible instructions, when executed, cause the machine to compute the PDF of the other-cell interference by:
measuring a plurality of other-cell interference signals for respective ones of a plurality of transmit time intervals; and
computing the PDF of the plurality of measured other-cell interference signals.

25. An article of manufacture as defined in claim 22, wherein the machine accessible instructions, when executed, cause the machine to select the modulation and coding scheme for the wireless device for a current transmit time interval based on the estimated noise contribution by:
computing an average block error rate based on the estimated noise contribution; and
selecting the modulation and coding scheme that maximizes an expected data rate.

26. An article of manufacture as defined in claim 25, wherein the estimated noise contribution is represented as a plurality of associated probabilities and signal-to-noise ratios, and wherein the machine accessible instructions, when executed, cause the machine to compute the average block error rate by:
determining a block error rate associated with each of the plurality of signal-to-noise ratios;
for each of the plurality of signal-to-noise ratios, multiplying the determined block error rate with the probability associated with the signal-to-noise ratio; and
adding together outputs of the multiplying.

27. An article of manufacture as defined in claim 25, wherein the machine accessible instructions, when executed, cause the machine to:
update the estimated noise contribution to include an intra-cell interference resulting from the selected modulation and coding scheme; and
select a second modulation and coding scheme for a second wireless device for the current transmit time interval based on the updated estimated noise contribution.

28. An article of manufacture as defined in claim 22, wherein the machine accessible instructions, when executed, cause the machine to rank a plurality of wireless devices, and selecting modulation and coding schemes for the plurality of wireless devices based upon the estimated noise contribution and based upon the ranking.
